(19) United States
(12) Patent Application Publication
(10) Pub. No.: US 2024/0100537 A1
(43) Pub. Date: Mar. 28, 2024

(54) METHODS FOR MANUFACTURING MINERAL CONTAINING PELLETS

(71) Applicant: 102062448 Saskatchewan Ltd., Corman Park (CA)

(72) Inventors: Donald Joseph Larmour, Saskatoon (CA); Donald Michael Larmour, Saskatoon (CA); Bradley V. A. Fettis, Corman Park (CA)

(21) Appl. No.: 18/262,907

(22) PCT Filed: Jan. 28, 2022
(86) PCT No.: PCT/CA2022/050126

§ 371 Date: Jul. 25, 2023

Related U.S. Application Data
(60) Provisional application No. 63/143,265, filed on Jan. 29, 2021.

(51) Int. Cl. B02C 4/02; B30B 11/22

(52) U.S. Cl. CPC B02C 4/02; B30B 11/222

(57) ABSTRACT

Methods and apparatuses for forming pellets, such as potash pellets, for example, are provided. The methods involve feeding agglomerate granules on to the operative surface of an assembly of rollers. The rollers are aligned to have parallel central rotational axes and there is a longitudinal gap between adjacent rollers. In order to form the pellets, the rollers are rotated to agitate and abrade the agglomerate granules on the operative surface of the assembly of rollers and form pellets.

### RELATED APPLICATION

This application claims the benefit of U.S. Provisional Patent Application No. 63/143,265 filed Jan. 29, 2021; the entire contents of Patent Application 63/143,265 are hereby incorporated by reference.

### FIELD OF THE DISCLOSURE

The present disclosure generally relates to the processing of raw materials, including mineral materials, which may be mined from subterranean geological formations. The present disclosure further relates to the manufacture of pellets from agglomerate granules.

### BACKGROUND

The following paragraphs are provided by way of background to the present disclosure. They are not however an admission that anything discussed therein is prior art or part of the knowledge of persons skilled in the art.

Raw materials, including raw mineral materials, such as potash, for example, may be extracted and recovered from subterranean geological formations either by conventional mining techniques, or by solution mining. The mined raw materials can be turned into finished forms or products which may vary depending on the desired specific chemical, industrial or agricultural application. For example, where the mined raw mineral materials are used in the formulation of an agricultural fertilizer, further processing of the raw mined mineral materials commonly includes a granulation step; that is to say, a step that involves agglomeration of small particles, having a particle size generally of less than 1 mm, in a feedstock of mineral containing these small particles, to form solid larger particles, referred to as granules, having a size generally in the range of from about 1 mm up to about 5 mm.

One commonly used granulation technique involves compaction of the small particle material feedstock. During compaction the mineral containing small particles within the feedstock are subjected to a sufficiently high pressure to squeeze the particles together and bring their surfaces close enough for short-range intermolecular and electrostatic forces to cause cohesion and form an agglomerate. The equipment used for compaction can be a roller compacter, or similar device. The product formed in a roller compacter is a sheet-like product, which is then further processed by controlled breakage of the sheet into agglomerate granules.

However, one of the limitations of the obtained compacted granules produced in this fashion is that they are irregularly shaped. The irregular shape of the granules causes practical problems during storage, handling, and application of the product. When agitated, irregularly shaped fertilizer granules, for example, have a tendency to generate dust. This is a significant nuisance when handling material, for example, during transport, in warehouses or workplaces. It should be noted that shipment of compacted granular material frequently occurs in bulk volumes using large equipment for transport such as rail cars and port cargo handling infrastructure, where gentle material handling to prevent the arisal of excessive dust is hardly an option. Furthermore, during the application of fertilizers, the scattering of dust particles by wind can raise environmental concerns, and dust may impede flow of product through hoses or pipeline, for example, and/or cause abrasion damage during handling and transport through conduits, hoses, pipes, augers, hoppers, bins, and the like.

Another shortcoming of irregular shaped compacted granules is that they have a tendency to cake. Product caking can occur during transport and storage and can impede product flow, and when caking occurs inside application equipment, such as fertilizer application equipment, this can lead to application inefficiencies. The caked material needs to be removed from the application equipment, and can no longer be used for the intended application.

Yet another limitation caused by the irregular shape of compacted granules is encountered when it is desirable to obtain a granular blend containing two or more types of granules, as is the case when agricultural fertilizer blends are produced, to include, for example, a blend of potash granules and nitrogen and/or phosphate granules. It is challenging to admix irregularly shaped granules with other granular products in a manner that results in a granular blend wherein the different types of granules are homogenously distributed.

Thus, the available techniques for processing mineral containing raw materials are insufficiently effective. There is, in particular, an ongoing need in the art for improved processes and techniques that yield mineral containing compacted products with improved storage, handling and application characteristics.

### SUMMARY

The following paragraphs are intended to introduce the reader to the more detailed description that follows and not to define or limit the claimed subject matter of the present disclosure.

In one broad aspect, the present disclosure relates to methods for the manufacture of mineral containing pellets.

Accordingly, in one aspect, in accordance with the teachings herein, the present disclosure provides, in at least one embodiment, a method of forming a plurality of pellets from a plurality of agglomerate granules, comprising the steps of:
(a) feeding the plurality of agglomerate granules on to an operative surface of an assembly of rollers, the rollers having been aligned to have parallel central rotational axes and spaced apart from one another so that there is a longitudinal gap between adjacent rollers, wherein the width of the longitudinal gap is smaller than a size of the pellets;
(b) rotating the rollers to agitate and abrade the agglomerate granules on the exterior operative surface of the assembly of rollers and form substantially rounded pellets; and
(c) discharging the pellets from the rollers.

In at least one embodiment, in an aspect, the agglomerate granules can be irregularly shaped.

In at least one embodiment, in an aspect, the pellets can be substantially rounded pellets.

In at least one embodiment, in an aspect, the substantially rounded pellets can be substantially spherical pellets having a diameter of from about 0.5 mm to about 5.0 mm.

In at least one embodiment, in an aspect, the substantially rounded pellets can be substantially geometrically spheroidal pellets having a semi-major axis and a semi-minor axis, being non equal in length, and ranging from about 0.5 mm to about 5.0 mm in length.

In at least one embodiment, in an aspect, the width of the longitudinal gap between the adjacent rollers can be from about 2.5 mm to about 0.25 mm less than the size of the diameter of the substantially spherical pellets or the semi-minor axis of the substantially geometrically spheroidal pellets.

In at least one embodiment, in an aspect, the agglomerate granules can be irregularly shaped compacted mineral containing granules, and the pellets can be mineral containing pellets.

In at least one embodiment, in an aspect, the assembly can be a planar assembly in which the rollers are arranged in a linear planar format.

In at least one embodiment, in an aspect, the planar assembly can be angled relative to a horizontal surface that supports the planar assembly, the rollers having first and second end portions, the second end portions being positioned vertically closer to the horizontal surface than the first end portions, and wherein the agglomerate granules are fed onto the exterior operative surface of the first end portions of the rollers, conveyed along the operative surface in a longitudinal direction and discharged near the second end portions of the rollers.

In at least one embodiment, in an aspect, the assembly can be a tubular assembly formed by a circular arrangement of rollers where the rollers are arranged so that there is an approximately tubularly shaped space at a center of the assembly of rollers, the approximately tubularly shaped space having first and second tubular spatial end portions and a central tubular axis that is parallel to central rotational axes of the rollers, wherein the agglomerate granules are received at the first or second tubular spatial end portion of the approximately tubularly shaped space.

In at least one embodiment, in an aspect, the assembly of rollers can be arranged so that the central tubular axis can be angled relative to a horizontal surface that supports the tubular assembly so that the first tubular spatial end portion is positioned vertically higher relative to the horizontal surface than the second tubular spatial end portion, wherein the agglomerate granules are fed into the first tubular spatial end portion, conveyed longitudinally through the tubular space, and discharged at the second tubular spatial end portion.

In at least one embodiment, in an aspect, the rollers in the linear or circular arrangement can be operated at the same rotational rate.

In at least one embodiment, in an aspect, the rollers in the linear or circular arrangement can all be operated at a first rotational rate for a first period of time, and are thereafter all operated at a second rotational rate for a second period of time, the second rotational rate being higher than the first rotational rate.

In at least one embodiment, in an aspect, the agglomerate granules can be fed on a roller assembly comprising a plurality of roller arrangements that are sequentially ordered, each roller arrangement having multiple rollers, and each roller arrangement is disposed in a linear or circular arrangement, wherein the rollers in each roller arrangement are operated at the same rotational rate, and wherein starting with a first roller sequence, the rollers in each subsequent roller arrangement, are operated at an incrementally higher rotational rate, and wherein the agglomerate granules are fed to the first roller arrangement, conveyed along all of the subsequent roller arrangements and discharged from a final roller arrangement.

In at least one embodiment, in an aspect, the plurality of roller arrangements can be arranged in a linear planar format, wherein the central axes of the rollers in at least one roller arrangement extend co-linearly to the central axes of the rollers of at least one other roller arrangement.

In at least one embodiment, in an aspect, the plurality of roller arrangements can be arranged in a linear planar format, wherein the central axes of the rollers in at least one roller arrangement extend in parallel with the central axes of the rollers of at least one other roller arrangement, and wherein the central axes of the at least one roller arrangement are axially offset from the central axes of the at least one other roller arrangement.

In at least one embodiment, in an aspect, the rollers can be disposed within an enclosed housing to prevent spillage of agitated agglomerate granules from the operative surface of the rollers.

In at least one embodiment, in an aspect, the rollers can have a length ranging from about 50 cm to about 4 m.

In at least one embodiment, in an aspect, the method can comprise heating the agglomerate granules at a temperature from about 30° C. to about 300° C. before feeding the granules onto an operative surface of the assembly of rollers.

In at least one embodiment, in an aspect, the method can comprise heating a plurality of irregularly shaped compacted mineral containing granules at a temperature from about 30° C. to about 300° C. before feeding the plurality of irregularly shaped agglomerate mineral containing granules onto an operative surface of the assembly of rollers.

In at least one embodiment, in an aspect, the width of the longitudinal gap between the rollers can be about 4 mm to about 0.25 mm.

In at least one embodiment, in an aspect, an average granule mass on a per granule basis can exceed an average pellet mass on a per pellet basis by at least 5%.

In at least one embodiment, in an aspect, the mineral in the plurality of irregularly shaped compacted mineral containing granules can be a potassium containing water soluble salt, or a phosphate containing water soluble salt.

In at least one embodiment, in an aspect, the potassium containing salt can be a single salt.

In at least one embodiment, in an aspect, the potassium containing salt can be a multiple salt.

In at least one embodiment, in an aspect, the single salt can be selected from KCl, K₂SO₄ and KNO₃.

In at least one embodiment, in an aspect, the multiple salt can be selected from K₂SO₄—MgSO₄—(CaSO₄)₂-2H₂O, K₂SO₄(MgSO₄)₂, K₂SO₄—MgSO₄-4H₂O, K₂SO₄—MgSO₄-6H₂O, and KCl—MgSO₄-2.75H₂O.

In at least one embodiment, in an aspect, the assembly can be operated under conditions where in at least 90% of the discharged pellets are substantially rounded, as empirically determined.

In another aspect, the present disclosure provides, in at least one embodiment, a plurality of pellets manufactured according to any of the methods of the present disclosure.

In at least one embodiment, in an aspect, the pellets can be substantially rounded mineral containing pellets.

In another aspect, the present disclosure provides, in at least one embodiment, a roller assembly for forming a plurality of pellets from a plurality of agglomerate granules, wherein the roller assembly comprises a plurality of rollers aligned to have parallel central rotational axes and a longitudinal gap between adjacent rollers, wherein the width of the longitudinal gap is smaller than a size of the pellets.

In at least one embodiment, in an aspect, the agglomerate granules can be irregularly shaped.

In at least one embodiment, in an aspect, the pellets can be substantially rounded pellets.

In at least one embodiment, in an aspect, the agglomerate granules can be irregularly shaped compacted mineral containing granules and the pellets are mineral containing pellets.

In at least one embodiment, in an aspect, the roller assembly can be a planar assembly in which the rollers are arranged in a side-by-side linear format.

In at least one embodiment, in an aspect, the planar assembly can be angled relative to a horizontal surface that supports the planar assembly, the rollers having first and second end portions, the second end portions being positioned vertically closer to the horizontal surface than the first end portions.

In at least one embodiment, in an aspect, the roller assembly can be a planar assembly arranged in a linear format disposed within an enclosed housing.

In at least one embodiment, in an aspect, the roller assembly can be a tubular assembly formed by a circular arrangement of the rollers where the rollers are arranged so that there is an approximately tubularly shaped space formed within the circular arrangement of the rollers, the approximately tubularly shaped space having a first and second tubular spatial end portion and a central tubular axis that is parallel to central rotational axes of the rollers.

In at least one embodiment, in an aspect, the roller assembly can be arranged so that the central tubular axis can be angled relative to a horizontal surface that supports the tubular assembly so that the first tubular spatial end portion is vertically positioned higher relative to the horizontal surface than the second tubular spatial end portion.

In at least one embodiment, in an aspect, the roller assembly can comprise a plurality of roller arrangements that are located in a serial fashion where each subsequent roller arrangement is downstream of a previous roller arrangement, each roller arrangement having multiple rollers, and each roller arrangement arranged in a linear or circular format.

In at least one embodiment, in an aspect, the plurality of roller of arrangements can be positioned in a sequential arrangement, wherein central axes of the rollers in at least one roller arrangement extend co-linearly to central axes of the rollers of at least one other roller arrangement.

In at least one embodiment, in an aspect, the plurality of roller arrangements can be positioned in a sequential arrangement, wherein central axes of the rollers in at least one roller arrangement extend in parallel with central axes of the rollers of at least one other roller arrangement, wherein the central axes of the at least one roller arrangement are axially offset from central axes of at least one other roller arrangement.

In at least one embodiment, in an aspect, the rollers can have a length in the range of about 50 cm to about 4 m.

In at least one embodiment, in an aspect, the width of the longitudinal gap between the rollers can be from about 4 mm to about 0.25 mm.

In another aspect, in an aspect, the present disclosure provides, in at least one embodiment, a plurality of substantially rounded mineral containing pellets manufactured according to the methods of the present disclosure.

Other features and advantages or the present disclosure will become apparent from the following detailed description. It should be understood, however, that the detailed description, while indicating preferred implementations of the present disclosure, is given by way of illustration only, since various changes and modification within the spirit and scope of the disclosure will become apparent to those of skill in the art from the detailed description.

### BRIEF DESCRIPTION OF THE DRAWINGS

The disclosure is in the hereinafter provided paragraphs described, by way of example, in relation to the attached figures. The figures provided herein are provided for a better understanding of the example embodiments and to show more clearly how the various embodiments may be carried into effect. Like numerals designate like or similar features throughout the several views, possibly shown situated differently, and/or from a different angle. Thus, by way of example only, part 105a in FIG. 1A, FIG. 1B, FIG. 1I, FIG. 5A, FIG. 5B and FIG. 5C corresponds to the same roller situated differently, and/or from a different angle in each of these figures. The figures are not intended to limit the present disclosure.

FIG. 1A is a perspective view of an example embodiment of an assembly of rollers comprising a linear arrangement of rollers.

FIG. 1B is a traverse cross sectional view of the assembly of rollers taken along the plane 1B in FIG. 1A.

FIG. 1C is a side cross sectional view of the assembly of rollers taken along plane 1C in FIG. 1A.

FIGS. 1D-1H are cross sectional views of a portion of the assembly of rollers shown in FIG. 1A in a first state, second state, third state, fourth state and fifth state, respectively.

FIG. 1I is a perspective view of another example embodiment of an assembly of rollers comprising a linear arrangement of rollers.

FIG. 2A is a perspective view of another example embodiment of an assembly of rollers comprising a linear arrangement of rollers.

FIG. 2B is a cross sectional view of the assembly of rollers taken along the plane 2B in FIG. 2A.

FIG. 3 is an enlarged view of the area marked 3 in FIG. 1B.

FIGS. 4A, 4B and 4C are transverse cross sectional views of the assembly of rollers shown in FIGS. 2A and 2B, in a single operational state, taken as indicated along planes 4A, 4B and 4C, respectively, in FIG. 2B.

FIG. 5A is a perspective view of another example embodiment of an assembly of rollers comprising a circular arrangement of rollers.

FIG. 5B is a transverse cross sectional view of the assembly of rollers taken along the plane 5B in FIG. 5A.

FIG. 5C is a view of portion 5C indicated in FIG. 5B.

FIG. 5D is a perspective view of another example embodiment of an assembly of rollers comprising a circular arrangement of rollers.

FIGS. 6A and 6B are side views of two example embodiments of an assembly of rollers comprising two arrangements of rollers that are sequentially positioned.

FIG. 7 is a perspective view of another example embodiment of an assembly of two arrangements of rollers that are sequentially positioned.

The figures together with the following detailed description make apparent to those skilled in the art how the disclosure may be implemented in practice.

### DETAILED DESCRIPTION

Various processes, systems and compositions will be described below to provide at least one example of at least one embodiment of the claimed subject matter. No embodiment described below limits any claimed subject matter and any claimed subject matter may cover processes, systems, or compositions that differ from those described below. The claimed subject matter is not limited to any process, system, or composition having all of the features of processes, systems, or compositions described below, or to features common to multiple processes, systems, or compositions described below. It is possible that a process, system, or composition described below is not an embodiment of any claimed subject matter. Any subject matter disclosed in processes, systems, or compositions described below that is not claimed in this document may be the subject matter of another protective instrument, for example, a continuing patent application, and the applicants, inventors or owners do not intend to abandon, disclaim or dedicate to the public any such subject matter by its disclosure in this document.

As used herein and in the claims, the singular forms, such as “a”, “an” and “the” include the plural reference and vice versa unless the context clearly indicates otherwise. Throughout this specification, unless otherwise indicated, the terms “comprise,” “comprises” and “comprising” are used inclusively rather than exclusively, so that a stated integer or group of integers may include one or more other non-stated integers or groups of integers. The term “or” is inclusive unless modified, for example, by “either”. The term “and/or” is intended to represent an inclusive or. That is “X and/or Y” is intended to mean X or Y or both, for example. As a further example, X, Y and/or Z is intended to mean X or Y or Z or any combination thereof.

When ranges are used herein for physical properties, such as molecular weight, or chemical properties, such as chemical formulae, all combinations and sub-combinations of ranges and specific embodiments therein are intended to be included. Other than in the operating examples, or where otherwise indicated, all numbers expressing quantities of ingredients or reaction conditions used herein should be understood as being modified in all instances by the term “about.” The term “about” when referring to a number or a numerical range means that the number or numerical range referred to is an approximation within experimental variability (or within statistical experimental error), and thus the number or numerical range may vary between 1% and 15% of the stated number or numerical range, as will be readily recognized by the context. Furthermore, any range of values described herein is intended to specifically include the limiting values of the range, and any intermediate value or sub-range within the given range, and all such intermediate values and sub-ranges are individually and specifically disclosed (e.g. a range of 1 to 5 includes 1, 1.5, 2, 2.75, 3, 3.90, 4, and 5). Similarly, other terms of degree such as “substantially” and “approximately” as used herein mean a reasonable amount of deviation of the modified term such that the end result is not significantly changed. These terms of degree should be construed as including a deviation of the modified term, such as up to 15% for example, if this deviation would not negate the meaning of the term it modifies.

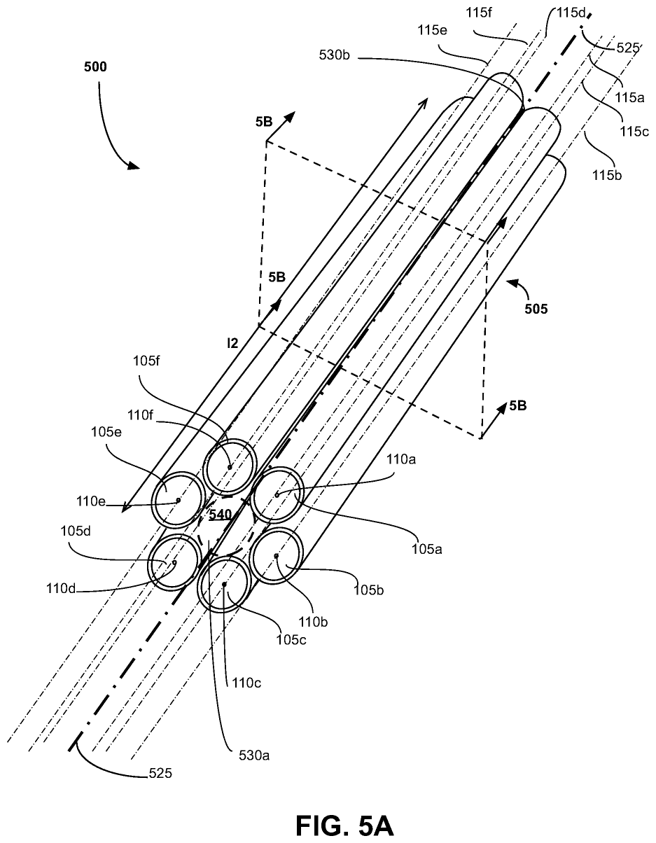

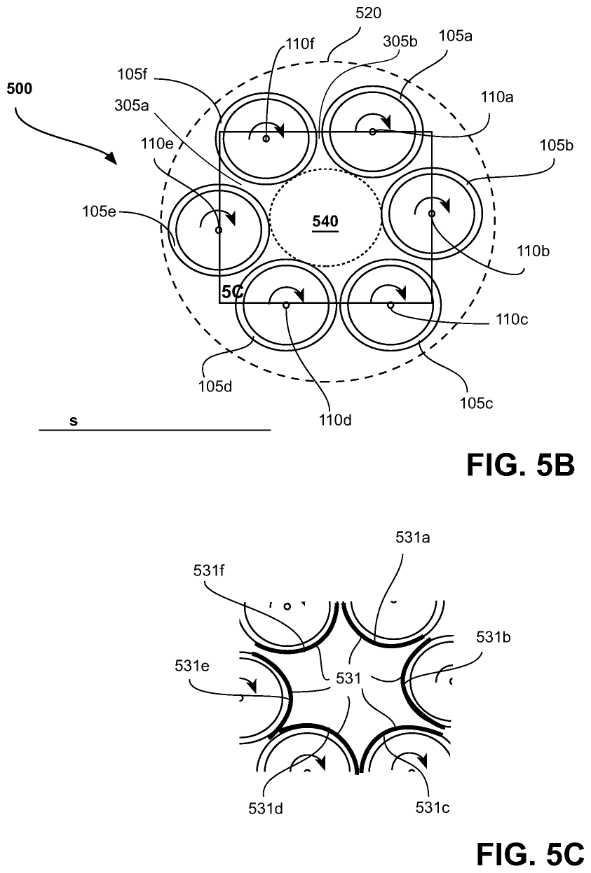

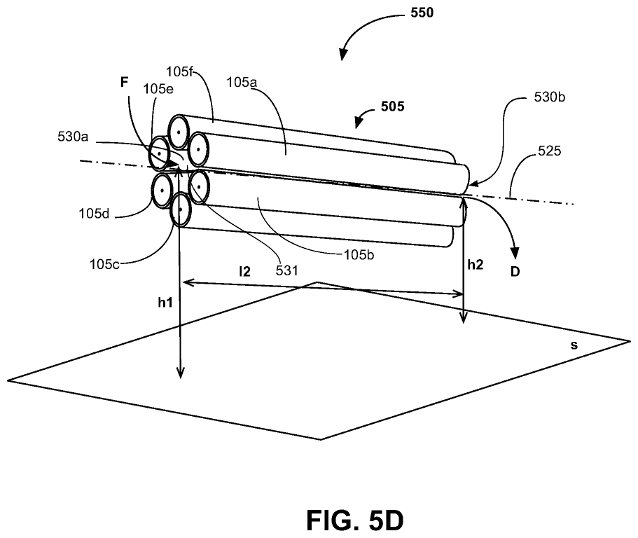

Several directional terms such as “above”, “below”, “lower”, “upper”, “vertical” and “horizontal” are used herein for convenience including for reference to the drawings. In general, the terms “upper”, “above”, “upward” and similar terms are used to refer to an upwards direction or upper portion in relation to the earth's surface s, as shown, for example in FIG. 5D. Similarly the terms “lower”, “below”, “downward”, and “bottom” are used to refer to a downwards direction or a lower portion relative to the earth's surface s, for example, such as shown in FIG. 5D. The term “vertical” is used herein to refer to a direction that is perpendicular to the earth's horizontal surface, while the term “horizontal” refers to a direction that is parallel relative to the earth's flat surface at zero incline.

Unless otherwise defined, scientific and technical terms used in connection with the formulations described herein shall have the meanings that are commonly understood by those of ordinary skill in the art. The terminology used herein is for the purpose of describing particular example embodiments only, and is not intended to limit the scope of the present invention, which is defined solely by the claims.

All publications, patents, and patent applications referred to herein are herein incorporated by reference in their entirety to the same extent as if each individual publication, patent, or patent application was specifically indicated to be incorporated by reference in its entirety.

In general, the methods of the present disclosure can be used to form pellets, for example, potash containing pellets.

In broad terms, the methods include feeding a plurality of agglomerate granules onto the exterior operative surface of an assembly of rollers. The rollers have been aligned to have parallel central rotational axes. The rollers are further assembled so that there remains a longitudinal gap having a width smaller than the size of the formed pellets between adjacent rollers. The rollers are rotated to abrade the granules and form pellets. Once formed, the pellets are discharged from the rollers.

The methods of the present disclosure can be used to obtain pellets, for example, substantially rounded mineral containing pellets. The obtained pellets exhibit substantially improved handling, storage, and application characteristics than the irregularly shaped compacted granules. For example, mineral containing substantially rounded pellets, when agitated, for example during transport or application, release substantially less dust than the irregularly shaped granules. Furthermore, the obtained pellets are less prone to caking, for example, when stored in bulk quantities or contained in an application equipment, than the irregularly shaped granules. It is further an advantageous feature of the methods and processing and apparatuses of the present disclosure, that the obtained pellets can be easily blended with other types of pellets to form a blend in which all types of pellets are homogenously distributed in the blend.

In what follows, selected example embodiments are described with reference to the drawings. It should be noted that while the embodiments of the methods and apparatuses of the teachings herein may be descried with reference to operation on irregular shaped agglomerate granules or mineral containing irregular agglomerate particles to create pellets, the embodiments may be applied to agglomerate granules in general.

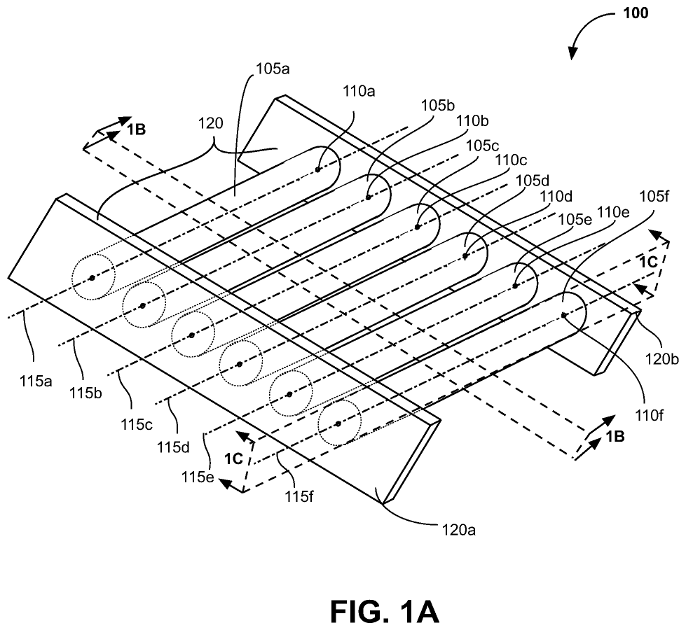

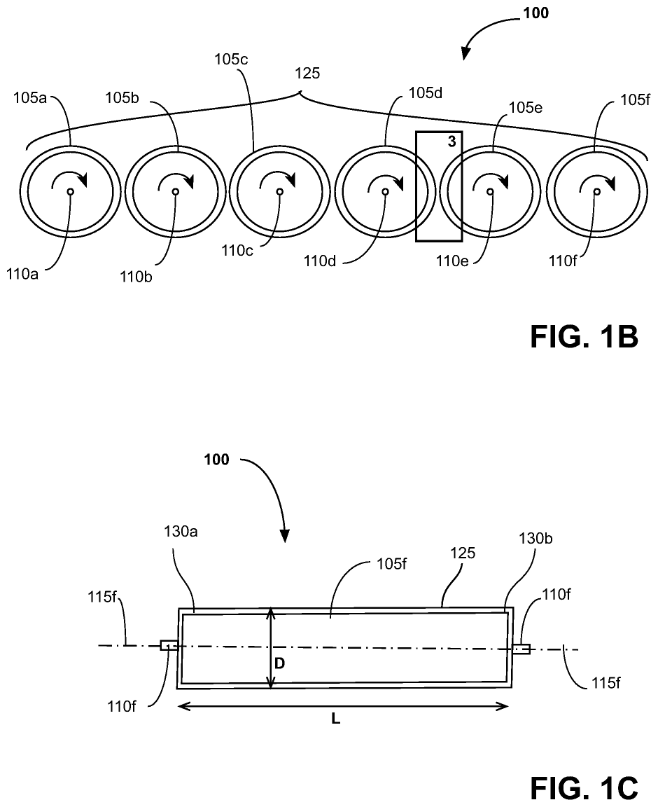

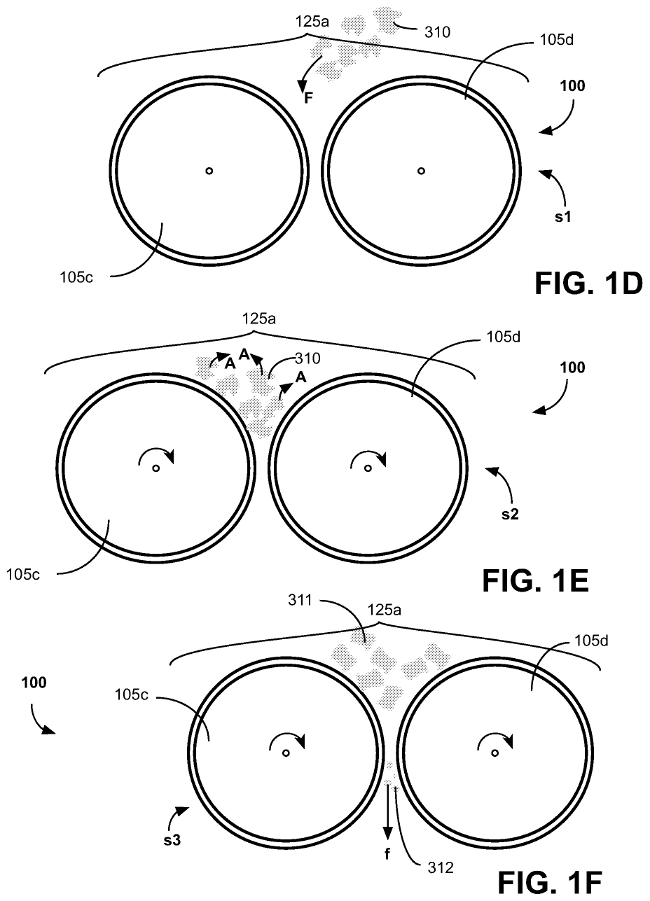

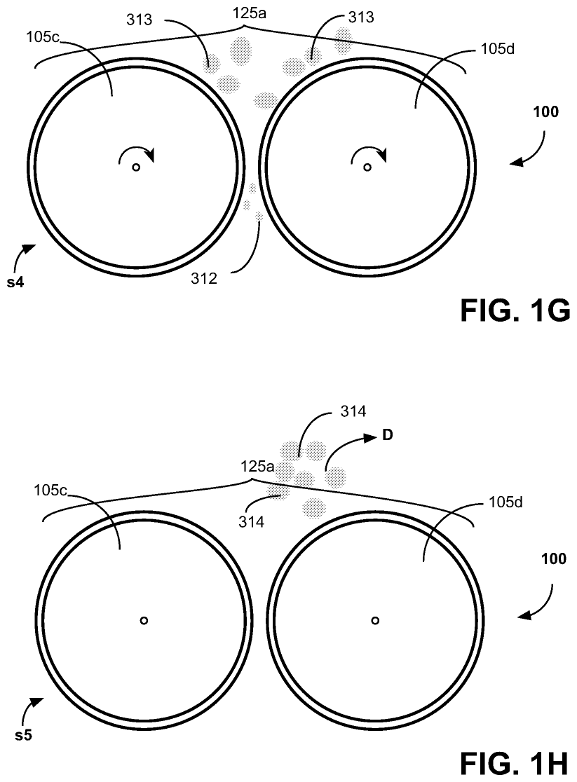

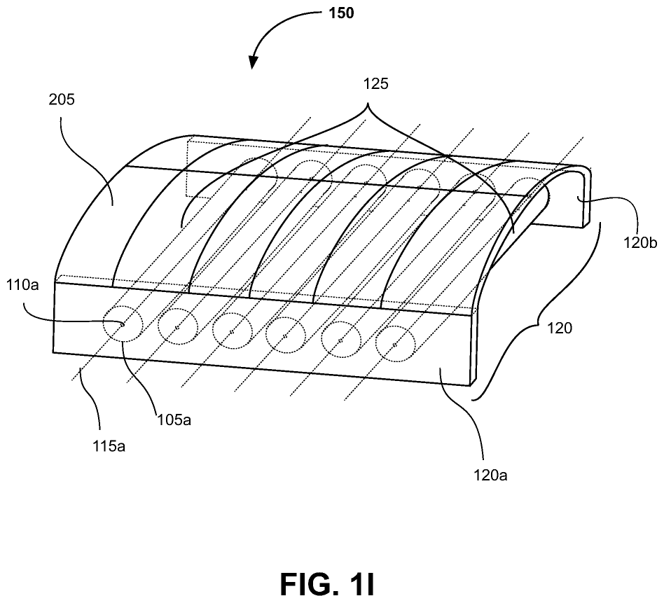

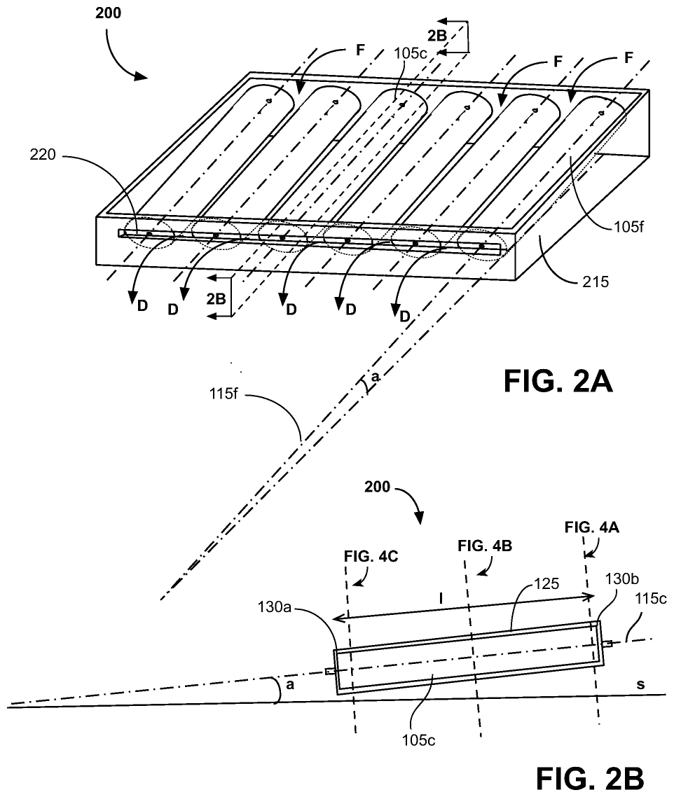

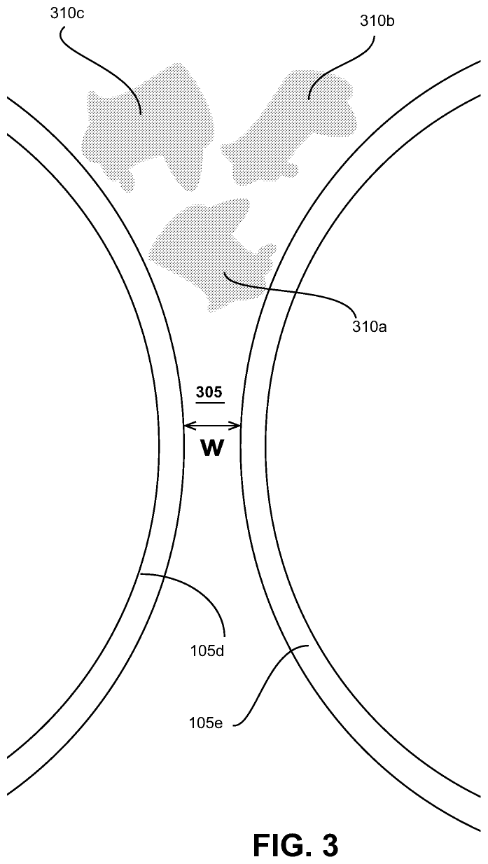

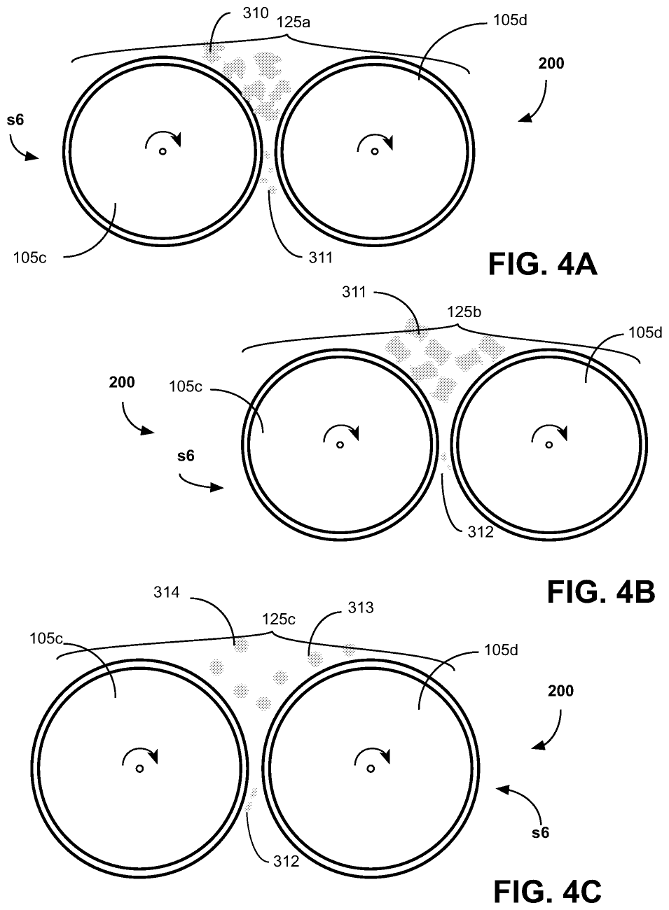

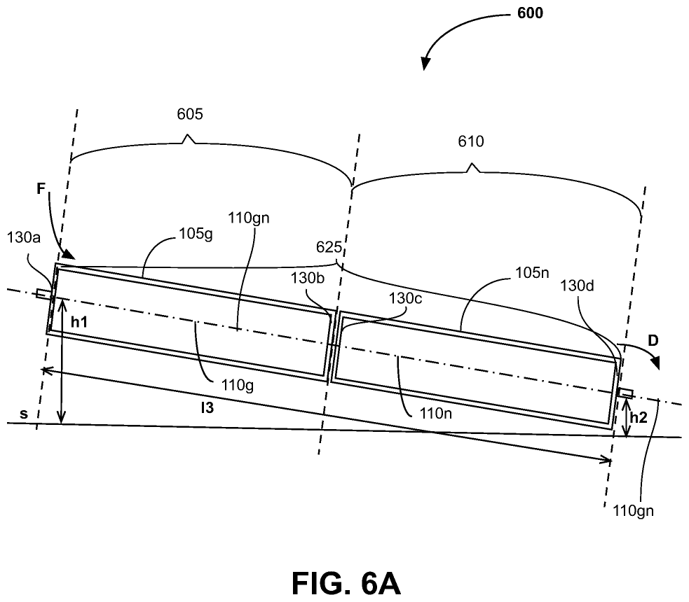

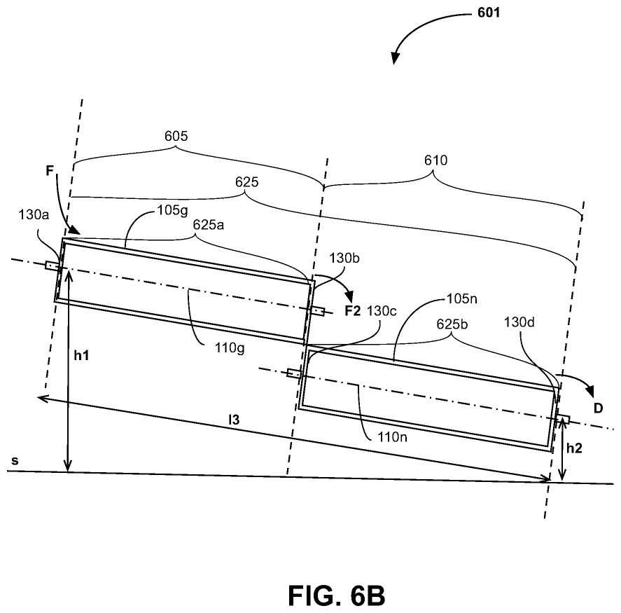

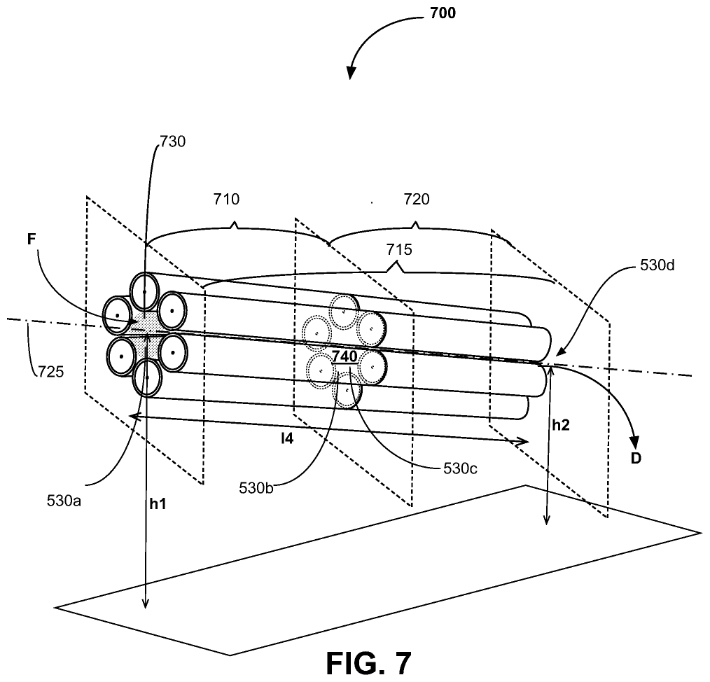

In general overview, FIGS. 1A-1C show several views of an example embodiment of a planar roller assembly 100 comprising a linear arrangement of rollers. FIGS. 1D-1H show a portion of planar roller assembly 100 in a first, second, third, fourth, and fifth state, respectively. FIG. 1I shows a view of another example embodiment of a planar roller assembly 150 comprising a linear arrangement of rollers. FIGS. 2A-2B show several views of another example embodiment of a planar roller assembly 200 comprising a linear sequence of rollers. FIG. 3 shows an enlarged view of the roller assembly 100 shown in FIGS. 1A-1C. FIGS. 4A-4C show sectional views of the roller assembly 200 shown in FIGS. 2A-2B in a single operational state. FIGS. 5A-5C show several views of another example embodiment of a tubular roller assembly 500 comprising a circular arrangement of rollers. FIG. 5D shows a view of another example embodiment of a tubular roller assembly 550 comprising a circular arrangement of rollers. FIGS. 6A and 6B show a view of example embodiments of planar roller assemblies 600 and 601, each comprising two linear arrangements of rollers that are ordered in sequential fashion. FIG. 7 shows a view of an example embodiment of a tubular roller assembly 700 comprising two circular arrangements of rollers that are ordered in sequential fashion.

Referring initially to FIGS. 1A-1C, shown therein is example roller assembly 100 for use in the manufacture of pellets from agglomerate granules. Roller assembly 100 includes rollers 105a, 105b, 105c, 105d, 105e, and 105f and frame 120. Rollers 105a, 105b, 105c, 105d, 105e, and 105f are mounted on the frame 120 and linearly aligned so that each of their respective longitudinal central axes 115a, 115b, 115c, 115d, 115e, and 115f run parallel between frame portions 120a and 120b of frame 120. Rollers 105a, 105b, 105c, 105d, 105e, and 105f include respective rotational axles 110a, 110b, 110c, 110d, 110e, and 110f allowing the rollers within frame 120 to rotate, independently from one another, about their respective longitudinal central axes 115a, 115b, 115c, 115d, 115e, and 115f (see: in particular FIG. 1C). Each of rollers 105a, 105b, 105c, 105d, 105e, and 105f can further be said to have two longitudinal end portions at either end thereof. It is noted that rotational axles 110a, 110b, 110c, 110d, 110e, and 110f are received by apertures within frame 120. In order to facilitate rotational movement of rotational axles 110a, 110b, 110c, 110d, 110e, and 110f within frame 120, the rotational axles 110a, 110b, 110c, 110d, 110e, and 110f may be constructed to include bushings, bearings, or the like, as will be understood by those of skill in the art. For illustrative purposes end portions 130a and 130b are expressly indicated with respect to one roller 105f in FIG. 1C. Length (L) of rollers 105a, 105b, 105c, 105d, 105e, and 105f in different embodiments may vary and can range, for example, from about 50 cm to about 4 meters. Diameter (D) of rollers 105a, 105b, 105c, 105d, 105e, and 105f in different embodiments may vary and can range, for example, from about 10 cm to about 100 centimeters. An undulating exterior operative surface 125 is formed by a collective exterior surface of the sequentially linearly aligned rollers 105a, 105b, 105c, 105d, 105e, and 105f as indicated in FIG. 1B. The exterior surface material of rollers 105a, 105b, 105c, 105d, 105e, and 105f may vary in different embodiments, and may, for example, be made with or coated with a steel alloy, a ceramic, high density polyethylene (HDPE) an epoxy resin, or be a rubber-lined surface. Furthermore the exterior surface material me be a smooth or rough surface.

It is noted that the linear arrangement of rollers shown in FIGS. 1A-1C includes six rollers. In other embodiments, a linear arrangement of rollers can include fewer rollers, for example at least two rollers. In other embodiments, a linear arrangement of rollers can include more rollers, for example, 7, 8, 9, 10, 11, 12, 13, 14, 15, 20, 25, 50, 100 or even more rollers.

Referring further to FIG. 1B in conjunction with FIG. 3, longitudinal gaps are formed between adjacent pairs of rollers 105a, 105b, 105c, 105d, 105e, and 105f in roller assembly 100. For illustrative purposes longitudinal gap 305 is expressly indicated with respect to roller pair 105d and 105e in FIG. 3. Longitudinal gap 305 can be said to have a width w.

In order to perform the methods of the present disclosure it is generally beneficial to couple rollers 105a, 105b, 105c, 105d, 105e, and 105f to a drive unit (not shown) to cause rotation of rollers 105a, 105b, 105c, 105d, 105e, and 105f. A drive unit, in this respect, can be coupled to rotational axles 110a, 110b, 110c, 110d, 110e, and 110f of rollers 105a, 105b, 105c, 105d, 105e, and 105f, and can be disposed exterior or interior to the frame 120 and be coupled to the rollers 105a, 105b, 105c, 105d, 105e, and 105f through a mechanical linkage that can be implemented using structures known to those skilled in the art. In certain embodiments, the drive unit can be disposed inside the roller body, such as described, for example, in U.S. Pat. No. 7,662,079.

Referring next to FIGS. 1D-1H, shown therein is a portion of planar roller assembly 100, notably two rollers 105c and 105d in a first state s1, a second state s2, a third state s3, a fourth state s4, and a fifth state s5, respectively. States s1, s2, s3, s4 and s5 occur at successively different time points, i.e., first state s1 occurs at a first time point. Second state s2 corresponds with a second time point occurring later than the first time point, and third state s3 corresponds with a third time point occurring later than the second time point, and so on. In general, during an example process illustrated by states s1, s2, s3, s4 and s5 agglomerate granules 310 are processed and formed into pellets, notably substantially rounded pellets 314. Next, prior to further discussing the example process illustrated by states s1, s2, s3, s4 and s5, the agglomerate granules will be discussed in some further detail.

In general, any agglomerate granules may be used in accordance herewith. The term ‘agglomerate’, in this respect, refers to granules having been formed by a process causing cohesion of material mass to form a granule. A process for forming granules includes, for example, particle compaction, i.e., pressing a solid particulate material under sufficiently high pressure to cause cohesion of material particles, and form e.g., a sheet like product, and subsequent breakage into compacted granules. Agglomerate granules may also be formed by melting a raw material, e.g., a particulate material, to form a liquid or semisolid material, solidifying the liquid or semi-solid material to form a solid material, and subsequently, for example, by breakage of a larger structure, forming agglomerate granules. Yet another manner in which agglomerate granules may be formed includes by tumbling particulate materials, e.g., in the presence of a binder, to cause cohesion of particles and ‘grow’ granules. Suitable agglomerate granules are generally sized from about 0.5 millimeter (mm) to about 50 mm (including e.g., about 1 mm, about 5 mm, about 10 mm, about 25 mm, about 30 mm, about 35 mm, about 40 mm, or about 45 mm), or from about 0.5 mm to about 5.0 mm (including e.g., about 1 mm, about 1.5 mm, about 2 mm, about 2.5 mm, about 3 mm, about 3.5 mm, about 4 mm, or about 4.5 mm). Any technology may be used to make agglomerate granules, including, for example, as noted, particle compaction, using, as is known to those of skill in the art, for example, a roller compacter or similar device. As is also known to those of skill in the art, where a compacting device, such as a roller compacter, yields sheets or sheet-like materials, ribbons, or ribbon-like materials, or flakes or flake-like materials, these may be further disrupted or broken in a controlled fashion, using, for example, a crusher granulator or hammer-mill granulator, to yield appropriate sized irregularly shaped granules.

In an aspect hereof, in an embodiment, irregularly shaped agglomerate granules may be used. The term ‘irregular’, in this respect, refers to granules having a non-smooth surface, i.e., a surface containing edges, indents, dimples, bulges, and the like, and may include a plurality of substantially non-identical irregularly shaped granules, and/or a plurality of substantially identical granules, e.g., a plurality of granules having a single similar bulge. Furthermore, it is noted that a plurality of irregularly shaped agglomerate granules may include irregularly shaped agglomerate granules and a small proportion of regularly shaped, or identical regularly shapes agglomerate granules, for example about 1%, about 5%, about 10%, about 20% or about 25%, or from about 1% to about 5%, from about 1% to about 10%, from about 1% to about 20%, or from about 1% to about 25% regularly shaped, or regularly shaped identical agglomerate granules.

The agglomerate granules may comprise, be substantially constituted, or be constituted of a variety of materials, including, without limitation, minerals, clays, polymers, plastics, pigments, detergents, fine chemicals, pharmaceuticals, or food or feed products.

In one example embodiment, irregularly shaped compacted mineral containing granules may be used in accordance herewith. Such granules may be obtained following mining of a mineral resource material and compacting smaller particles, including crystalline particles, generally sized less than about 0.5 mm, for example ranging from about 0.1 mm to no more than about 0.5 mm (including e.g., about 0.2 mm, about 0.3 mm, or about 0.4 mm) and compacting these particles into granules having a size from about 0.5 mm to about 50 mm (including e.g., about 40 mm, about 30 mm, about 25 mm, about 20 mm, about 15 mm, or about 10 mm), or from about 0.5 mm to about 5.0 mm (including e.g., about 1 mm, about 1.5 mm, about 2 mm, about 2.5 mm, about 3 mm, about 3.5 mm, about 4 mm, or about 4.5 mm).

With respect to the minerals, the granules may contain any mineral. In one embodiment, the mineral may be a mineral used for agricultural fertilization, for example, a potassium (K), nitrogen (N), or phosphorus (P) containing mineral.

In some embodiments, the mineral can be a potassium containing water soluble salt. In this respect, it is noted that the term “potash”, as used herein, refers to any potassium containing water soluble salt. The potassium containing water soluble salt can be a single salt, such as KCl, K₂SO₄ and KNO₃, for example, or the potassium containing water soluble salt can be a multiple salt, for example, the triple salt K₂SO₄—MgSO₄—(CaSO₄)₂-2H₂O (also known as polyhalite), the double salt K₂SO₄(MgSO₄)₂ (also known as langbeinite), the double salt K₂SO₄—MgSO₄-4H₂O (also known as leonite), the double salt K₂SO₄—MgSO₄-6H₂O (also known as schoenite), or the double salt KCl—MgSO₄-2.75H₂O (also known as kainite; a slight fractional change in the number of water molecules has also been reported: i.e., KCl—MgSO₄-3H₂O, however this is currently believed to reflect a detection inaccuracy). The water soluble potassium containing salts can also be monocationic potassium salts, such KCL and KNO₃, for example, or dicationic potassium salts such as K₂SO₄.

In some embodiments, the mineral can be a phosphate (PO₄³⁻) containing water soluble salt.

Referring next again to the drawings of the present disclosure, the manufacture of mineral containing pellets using irregularly shaped compacted mineral containing granules as a feedstock will be discussed to illustrate example methods and assemblies disclosed herein. It is to be understood however that techniques and methods other than compacting may be used to prepare the irregularly shaped compacted mineral containing granules. Furthermore, it is to be understood that other irregularly shaped agglomerate granules than compacted mineral containing granules may be used in accordance with the present disclosure. In general, any irregularly shaped agglomerate granules may be used in accordance herewith.

Turning back now to FIGS. 1D-1H, and referring initially to FIG. 1D, at first state s1 compressed mineral containing granules 310 are being fed (F) onto and received by exterior operative surface portion 125a of undulating exterior operative surface 125 of planar roller assembly 100. As an example, exterior operative surface portion 125a, which is formed by rollers 105c and 105d, is shown but it should be understood that the process illustrated in FIGS. 1D-1H applies to other portions of the planar exterior operative surface formed by two or more of the other rollers. It is noted that agglomerate granules 310 have a geometrically irregular exterior shape, and have a size that is larger than the width of the longitudinal gap between rollers 105c and 105d (see: FIG. 3), and thus granules 310 do not fall downwards through the longitudinal gap between rollers 105d and 105e. In first state s1, the rollers 105c and 105d are stationary.

In addition to the granules 310 being larger sized than the width of the longitudinal gap between rollers 105c and 105d, the formed pellets are also large sized than the width of the longitudinal gap, and do also not fall downwards through the longitudinal gap between rollers 105d and 105e. Thus, in some embodiments, the width of the longitudinal gap between adjacent rollers can be from about 2.5 mm to about 0.25 mm less than the size of the granules, for example, about 2 mm less, about 1.5 mm less, or about 1 mm less, or about 0.75 mm less, or about 0.5 mm less, than the size of the formed granules. In some embodiments, the width of the longitudinal gap between adjacent rollers can be from about 2.5 mm to about 0.25 mm less than the size of the formed pellets, for example, about 2 mm less, about 1.5 mm less, or about 1 mm less, or about 0.75 mm less, or about 0.5 mm less, than the size of the formed pellets.

In some embodiments, the width of the longitudinal gap between the adjacent rollers can be about 2.5 mm or less (for example, about 2.5 mm, about 2.0 mm, about 1.5 mm, about 1 mm, about 0.5 mm, or about 0.25 mm), about 1.5 mm or less, about 1 mm or less, about 0.5 mm or less, or about 0.25 mm or less.

Referring next to FIG. 1E, at second state s2, rollers 105d and 105e are rotating clock-wise. The rotational movement of rollers 105d and 105e results in agitation (A) of granules 310 on exterior operative surface portion 125a. It is noted that the rotational direction may be varied and in other embodiments, the rollers can be rotated counter clock-wise. In general, however the rollers, in accordance with the methods provided herein, are preferably operated so that they rotate in the same rotational direction. In some embodiments, the rollers may be rotated in a first direction for a first period of time and then in an opposite direction for a second period of time. In some embodiments, the direction of rotation of the rollers may be periodically alternated between clockwise and counterclockwise directions.

Referring next to FIG. 1F, at third state s3, the granules 310 have been agitated for a period of time. Such agitation causes abrasion and reshaping of the granules 310 so that reshaped granules 311 are formed. In this respect, reshaped granules 311 are granules from which irregularities on their exterior surface have been partially removed. At the same time, as reshaped granules 311 are being formed, abraded small particulate material 312 is generated. At third state s3, the abraded small particulate material 312 falls downwards (f) through the longitudinal gap between rollers 105d and 105e.

Referring next to FIG. 1G, at fourth state s4, the granules 311 have been agitated for a further period of time as a result of the ongoing rotational movement of rollers 105d and 105e. This causes further abrasion of the granules 311 and the formation of geometrically more regularly shaped granules 313, e.g., the granules 313 are more spheroidically shaped compared to when they were first provided to the roller assembly. At the same time, more abraded small particulate material 312 is generated and falls downwards through the longitudinal gap between rollers 105d and 105e.

Referring next to FIG. 1H, at fourth state s5, the rotational movement of rollers 105d and 105e has been halted at a time after the formation of geometrically approximately regularly shaped granules, which can be said to be substantially rounded pellets 314. Approximately rounded pellets 314 may now be recovered and discharged (D) from exterior operative surface portion 125a.

The term “substantially rounded”, as used herein, means that the pellets have a substantially smooth surface and a spheroid three dimensional geometry, i.e., a geometry obtainable by rotating an ellipse about one of its principal axes, or, in a special case, by rotating a circle about its diametrical axis. In this respect, geometrical spheroidal geometries can be defined by a semi-major axis and a semi-minor axis, which are non-equal in length, as is known by those of skill in the art. By contrast, spherical geometries can be defined as being completely symmetrical around its center, with all points on the surface lying the same distance from the center point. Thus, the term ‘geometrically spheroidal’, as used herein, is intended to exclude spherical geometries. However the term ‘spheroid’, is intended to include both spherical geometries, and geometrically spheroidal geometries. Substantially rounded pellets include substantially spherical pellets i.e., pellets either having a shape not deviating substantially from a perfect sphere, which, as noted, is defined as being completely symmetrical around its center, with all points on the surface lying the same distance from the center point. For example, the term “substantially spherical” means, when viewing any cross-section of the pellet, the difference between the average major diameter and the average minor diameter is less than 10%, such as less than 7.5%, or less than 5%. Substantially rounded pellets also include substantially geometrically spheroidal pellets. Thus, the substantially rounded pellets may have an approximately oblate or approximately prolate geometrically spheroidal geometry, notably an approximately oblate or approximately prolate geometrically spheroid geometry having two principal axes, non-equal in length, each axis ranging in length from about 0.5 mm to about 5.0 mm, for example, a semi-minor axis of 1 mm, and a semi-major axis of 3 mm. Furthermore, when considering a plurality of pellets, notably a representative plurality of pellets, such as may be obtained by sampling, the term “substantially rounded” is intended to be applicable to at least 90%, at least 95%, or at least 99% of the pellets within the plurality of pellets.

It will be understood that the granules 310 are generally larger in size than pellets 314. Thus, in particular, when the average mass per granule 310 is compared to the average mass per pellet 314, the average mass per granule 310 exceeds the average mass per pellet 314. As will be clear to those of skill in the art, the average mass of a pellet or granule, for example, in a lot of pellets or granules, may be determined by weighing a sample containing a known number of pellets or granules, for example, 100 pellets or granules, to determine the mass thereof, and dividing the mass by the known number of pellets or granules. The average mass per granule 310 may then be compared with the average mass per pellet 314. Thus, for example, the average mass per granule 310 can exceed the average mass per pellet 314 by, for example, 5% or about 5%, or at least or up to 5% or about 5%; 7.5% or about 7.5%, or at least or up to 7.5% or about 7.5%; 10% or about 10%, or at least or up to 10% or about 10%; 15% or about 15%, or at least 15% or up to about 15%; 20% or about 20%, or at least 20% or up to about 20%; 25% or about 25%, or at least 25% or up to about 25%; 30% or about 30%, or at least 30% or up to about 30%.

The time required to achieve substantially rounded particles may vary somewhat under different operating conditions. Thus, for example, variables include the selected granular material, rotational rates, and/or temperature of the initial granular material. In this respect, samples of the granules and/or pellets may be obtained at different time points and the pellets may be examined with respect to their geometry to determine if the pellets are substantially rounded, and a suitable empirical time can be selected to halt the rotation of the rollers and discharge the particles during subsequent use of the roller assembly.

Discharge of the substantially rounded pellets 314 may be achieved using any convenient means for collecting the substantially rounded pellets 314, for example, using a scoop, dredge, bail, or the like, to collect the pellets, from undulating exterior operative surface 125. Furthermore, as hereinafter described with respect to alternate embodiments gravitational force may be used to discharge substantially rounded pellets 314.

In some embodiments, the recovered substantially rounded pellets 314 can be spherical or substantially spherical and have a diameter ranging in size from about 0.5 mm to about 5.0 mm, for example about 1 mm, about 1.5 mm, about 2.0 mm, about 2.5 mm, about 3.0 mm, about 3.5 mm, about 4.0 mm, or about 4.5 mm.

It is noted that in some embodiments, the width of the longitudinal gap between the rollers can be about 2.5 mm less than the size of the substantially spherical pellets for example about 2.0 mm less, about 1.5 mm less, about 1.0 mm less, about 0.5 mm less, or about 0.25 mm less than the size of the pellets, and wherein the substantially spherical pellets can have a diameter ranging from about 0.5 mm to about 5.0 mm, for example about 1.0 mm, about 1.5 mm, about 2.0 mm, about 2.5 mm, about 3.0 mm, about 3.5 mm, about 4.0 mm or about 4.5 mm, provided however, the width of the longitudinal gap is less than the diameter of the substantially spherical pellets.

In some embodiments, the recovered substantially rounded pellets 314 can be substantially geometrically spheroidal or geometrically spheroidal, and have a semi-minor axis and a semi-major axis ranging in size from about 0.5 mm to about 5.0 mm, for example, about 1.0 mm, about 1.5 mm, about 2.0 mm, about 2.5 mm, about 3.0 mm, about 3.5 mm, about 4.0 mm, or about 4.5 mm.

It is noted that in some embodiments, the width of the longitudinal gap between the rollers can be about 2.5 mm less than the size of the semi-minor axis of the geometrically spheroidal pellets, for example about 2.0 mm less, about 1.5 mm less, about 1.0 mm less, about 0.5 mm less, or about 0.25 mm, less than the size of the semi-minor axis of the substantially geometrically spheroidal pellets, and wherein the substantially geometrically spheroidal pellets can have a diameter ranging from about 0.5 mm to about 5.0 mm, for example about 1.0 mm, about 1.5 mm, about 2.0 mm, about 2.5 mm, about 3.0 mm, about 3.5 mm, about 4.0 mm or about 4.5 mm, provided however, the width of the longitudinal gap is less than the size of the semi-minor axis of the substantially geometrically spheroidal pellets.

It is further noted that it is possible to also recover the small particulate material 312. The small particulate material 312 may be disposed of as waste. Alternatively, however, the small particulate material 312 may be re-used for further compacting and generating additional irregularly shaped agglomerate granules, which then can be used again for forming pellets.

The operating conditions of roller assembly 100 may be varied. Notably, the rotational rate and duration of rotation for the rollers of roller assembly 100 may be varied. Thus, for example, the rotational rate may range from about 50 rotations per minute to 500 rotations per minute. The duration of the rotations may range, for example, and the roller may be rotated for brief time intervals, or more or less continuously. As noted above, samples of the agglomerate granules and/or pellets may be obtained at certain time points during the rotation of the rollers, and thus pellets may be examined with respect to their geometry at different times and/or rotational rates, and a suitable rotational rate and time can be empirically selected to halt the rollers and discharge the particles during subsequent use of the roller assembly. Furthermore, the rotational rate may be adjusted (typically through control of the drive unit), so that for a first period of time the rollers are being rotated at a first rotational rate, and for a second period of time, the rollers are operated at a second rotational rate. In general, the rotational rate is increased during the second period of time, since the initial irregularly shaped granules are more prone to breakage, and concomitant loss, compared to the more regularly shaped granules as a result of the agitational forces being exerted. Hence, initially limiting the rotational rate to thereby limit the agitational forces may limit breakage and loss, may be beneficial.

A further operating condition that may be varied is the temperature of the irregularly shaped granules. In particular, it has been found that when heated irregularly shaped granules are being fed on the roller assembly, it is possible to reduce the duration of rotation and/or the rotational rate required to form substantially rounded pellets. In one embodiment, the granules can be heated to a temperature in a range from about 30° C. to about 300° C., or in a range from 30° C. to about 150° C., such as, for example, about 40° C., 50° C., 60° C., 70° C., 80° C., 90° C., 100° C., 110° C., 120° C., 130° C., or 140° C. and then fed to roller assembly 100.

It is noted that, in general, operating conditions can vary depending on the selected compacted granular material that is used. The operating conditions of roller assembly 100 can readily be adjusted or optimized by those of skill in the art. For example, roller assembly 100 can be operated under several test conditions, by selecting, e.g., several rotational rates and/or several periods of duration of rotation and optionally preheating the granules to several different temperatures as noted earlier, and then the geometries of the pellets obtained under the selected conditions can be evaluated to determine the operating conditions that provides the best results in terms of the shape of the time and power needed to obtain pellets with desired geometries. Following such evaluation, desired or optimized operating conditions, notably operating conditions yielding substantially rounded pellets, of roller assembly 100 may be selected.

Thus, it will now be understood that roller assembly 100 can be used to initially receive a plurality of irregularly shaped compacted mineral containing agglomerate granules on to the exterior operative surface of the rollers of the roller assembly. The rollers can then be rotated to agitate and abrade the granules on to the exterior operative surface of the rollers and form substantially rounded mineral containing pellets. The rollers may then be stopped, if needed, and the pellets may then be recovered. The resulting pellets will generally exhibit desirable storage, handling, and application characteristics. For example, the inventors have determined that the pellets formed by the roller assemblies and associated methods of operation described herein are less prone to caking, or to generating dust when handled. Furthermore, the inventors have determined that pellets formed by the roller assemblies and associated methods of operation described herein can readily be mixed with other types of pellets to obtain a mixture in which the pellets are homogenously distributed in the mixture.

Referring next to FIG. 1I, shown therein is another example roller assembly 150 for use in the manufacture of substantially rounded pellets from compacted mineral containing agglomerate granules. Roller assembly 150 includes six rollers, arranged in a linearly aligned format, in a similar fashion as roller assembly 100 shown in FIGS. 1A-1C. For simplicity's sake, only roller 105a, its longitudinal central axis 110a and central axel 115a have been expressly indicated in FIG. 1I. The central axes of all rollers are aligned to run parallel to one another and all rollers of roller assembly 150 are able to rotate independently from one another, about their respective longitudinal central axes. Frame 120 includes portions 120a and 120b, and further includes a cover portion 205 disposed above undulating exterior operative surface 125. Roller assembly 150 can thus be said to be disposed within an enclosed housing that is provided by the frame 120 and the cover portion 205. In the operation of roller assembly 150, agglomerate granules are agitated on undulating exterior operative surface 125 of the rollers. In the absence of cover portion 205 agglomerate granules and pellets may spill. Accordingly, in the operation of roller assembly 150, the enclosed housing with the cover 205 can prevent spilling of agglomerate granules and pellets. It is noted that in some embodiments, cover portion 205 may be removably and/or rotatably attached, including for example by being coupled to frame 120 via one or more latches and/or hinges. A removably attached cover portion 205 may facilitate inspection, servicing, or replacement of the rollers. The cover portion 205 may be a lid that is rotatably attached to the frame 120. In another embodiment, the cover portion 205 may be a lid that slidably engages the upper portion of the frame 120.

Next, further example embodiments will be discussed, notably an example embodiment 200 (shown in FIGS. 2A-2B and FIGS. 4A-4C), another example embodiment 500 (shown in FIGS. 5A-5B), another example embodiment 600 (shown in FIG. 6), and yet another example embodiment 700 (shown in FIG. 7).

Referring next to FIGS. 2A-2B, shown therein is another example roller assembly 200 for use in the manufacture of substantially rounded pellets from compacted mineral containing agglomerate granules. Roller assembly 200 again includes six rollers, in a linearly aligned format, like roller assemblies 100 and 150 shown in FIGS. 1A-1H and 1I, respectively. Frame 215 is constructed in such a manner that the rollers are angled relative to substantially horizontal surface s, as can be appreciated, in particular, by referring to FIG. 2B. Angle (a) illustrated with respect roller 105c can vary in different embodiments but is quite modest, ranging in different embodiments from as little as about 0.5 degrees to no more than about 15 degrees.

Referring next to FIGS. 4A-4C, shown therein is a single operational state s6 of two rollers 105c and 105d of roller assembly 200. FIG. 4A represents a cross section of rollers 105c and 105d in the proximity of end portion 130b (see: FIG. 2B) representing a portion 125a of exterior operative surface 125 FIG. 4B represents a cross section of rollers 105c and 105d approximately midway between end portions 130a and 130b, representing yet another portion 125b of exterior operative surface 125, while FIG. 4C represents a cross section of rollers 105c and 105d in the proximity of end portion 130a (see: FIG. 2B), representing another portion 125c of exterior operative surface 125. In the operation of roller assembly 200, irregularly shaped granules 310 are fed (F) onto and received by roller assembly 200 at end portion 130b, which is vertically higher than the end portion 130a with respect to surface s. As rollers 105c and 105d are rotating irregularly shaped granules 310 are agitated and abraded. Angle (a) causes gravitational forces to provide for migration of the granules from end portion 130b along the length (l) of rollers 105c and 105d (the same effect occurs for the other rollers in roller assembly 200) downwards towards end portion 130a. As the granules migrate downwards along different portions 125a, 125b and 125c of exterior operative surface 125, irregularly shaped agglomerate granules are formed into granules 311 for which irregularities on their exterior surface have been partially removed, and then into geometrically more regularly shaped granules 313. Approximately rounded pellets are discharged (D) from end portion 130a of rollers 105c and 105d (and the other rollers in roller assembly 200). In this respect frame 215 includes an aperture 220 that is transverse to the longitudinal axes of the rollers of roller assembly 200 and situated downstream of the end portions 130a of the rollers of roller assembly 200, through which substantially rounded pellets can be discharged. It is noted that in contrast to roller assembly 100, roller assembly 200 readily allows for a continuous flow and processing of granular material due to the automated discharge of the substantially rounded pellets.

Referring next to FIGS. 5A-5C, shown therein is another example roller assembly 500 for use in the manufacture of substantially rounded pellets from compacted mineral containing agglomerate granules. Roller assembly 500 includes rollers 105a, 105b, 105c, 105d, 105e, and 105f. Rollers 105a, 105b, 105c, 105d, 105e, and 105f are arranged in a circular format and aligned so that each of their respective longitudinal central axes 115a, 115b, 115c, 115d, 115e, and 115f are parallel and these rollers together form tubular assembly 500 having a length l2. As is the case for the assemblies 100, and 200, each roller 105a, 105b, 105c, 105d, 105e, and 105f is separated from the adjacent roller by longitudinal gaps (see, for example, 305a, 305b in FIG. 5B). Rollers 105a, 105b, 105c, 105d, 105e, and 105f include respective rotational axles 110a, 110b, 110c, 110d, 110e, and 110f allowing the rollers to rotate, independently from one another, about their respective longitudinal central axes 115a, 115b, 115c, 115d, 115e, and 115f. The rotational axles 110a, 110b, 110c, 110d, 110e, and 110f can be rotatably connected to a frame and a drive unit, as was similarly described for roller assemblies 100, 150 and 200. Tubular assembly 500 includes central tubular space 540 (as can be clearly seen in FIG. 5B) having central tubular axis 525, and tubular spatial end portions 530a and 530b. An interiorly facing tubular exterior operative surface 531 is formed by the collective interiorly facing exterior surfaces 531a, 531b, 531c, 531d, 531e and 531f of circularly arranged rollers 105a, 105b, 105c, 105d, 105e, and 105f, as highlighted in FIG. 5C.

It is noted that in the orientation shown in FIGS. 5B and 5C rollers 105c and 105d are those that are positioned closest to surface s. In the operation of roller assembly 500, granules are fed onto interiorly facing tubular exterior operative surface 531, notably onto portions 531c and 531d of interiorly facing tubular exterior operative surface 531. However, as roller assembly 500 is operated, and granules are agitated on interiorly facing tubular exterior operative surface 531, contact between the granules and other portions of interiorly facing tubular exterior operative surface 531, formed by 531a, 531b, 531e and 531f generally occurs.

Referring next to FIG. 5D, in conjunction with FIGS. 5A and 5B, shown therein is tubular assembly 500 disposed relative to horizontal surface s, so that tubular spatial end portion 530b of tubular assembly 500 is positioned vertically closer to horizontal surface s than end portion 530a (h1 is longer than h2). In order to operate roller assembly 500, irregularly shaped agglomerate granules are fed (F) into and received by the interiorly facing tubular exterior operative surface 531 of tubular assembly 500 at end portion 530a. As rollers 105a, 105b, 105c, 105d, 105e, and 105f rotate, irregularly shaped agglomerate granules are agitated and abraded. The height differential between h1 and h2 causes gravitational force to provide for migration of the granules from tubular spatial end portion 530a along the length (l2) of tubular roller assembly 505 downwards towards tubular spatial end portion 530a. Analogous to roller assembly 200, as the agglomerate granules migrate downwards along different portions of interiorly facing tubular exterior operative surface 531, irregularly shaped agglomerate granules are formed into granules for which irregularities on their exterior surface have been partially removed, which are in turn formed into geometrically more regularly shaped granules. Approximately rounded pellets are discharged (D) from tubular spatial end portion 530b of tubular assembly 505. It is noted that roller assembly 500 readily allows for a continuous flow and processing of granular material. In an alternative embodiment, the roller assembly 500 may comprise a substantially horizontally (relative to a horizontal surface) positioned tubular assembly (not shown). Such an embodiment may however be less suitable for continuous flow of granular material.

It is noted the circular arrangement of rollers shown in FIGS. 5A-5D includes six rollers. In other embodiments, the circular arrangement of rollers can include fewer rollers, however a circular arrangement of rollers preferably can include no less than three rollers. In other embodiments, a circular arrangement of rollers can include more rollers such as, for example, 7, 8, 9, 10, or more rollers. Unlike a linear arrangement of rollers, a circular arrangement of rollers including a large number of rollers such as, for example, 25 or more rollers, may be somewhat less practical or useful to implement, since the tubular assembly may have a large diameter and the rollers positioned at the top of the assembly may contribute little to the granular abrasion.

Referring next to FIG. 6A, shown therein is another example roller assembly 600 for use in the manufacture of substantially rounded pellets from compacted mineral containing agglomerate granules. Roller assembly 600 is a planar roller assembly constituted by two separate linear roller arrangements 605 and 610 that are coupled to one another, where each linear roller arrangement contains a plurality of rollers (e.g., 6, 7, 8, 9, 10 or more rollers; the amount of rollers not visible in the shown cross-sectional view), and together roller arrangements 605 and 610 form a planar roller assembly. The exterior operative surface 625 of roller assembly 600 is formed by rollers from both of the linear roller sequences 605 and 610 together. Shown in the cross-sectional view (analogous to the views of FIGS. 1C and 2B) are rollers 105g and 105n. In each linear roller arrangement 605 and 610, the rollers have an end portion. Shown are, with respect to roller 105g (and linear roller arrangement 605) end portions 130a and 130b, and with respect to roller 105n (and linear roller arrangement 610), end portions 130c and 130d. Roller 105g has a central axis 110g, and roller 105n has a central axis 110n. End portions 130a, 130b, 130c, and 130d are aligned in such a manner that central axis 110g extends directly to central axis 110n in a linear fashion so that these central axes together form central axis 110gn of roller pair 105g, 105n. Furthermore, taken together, linear roller arrangements 605 and 610 have a length l3.

Continuing to refer to FIG. 6A, it is noted that roller assembly 600 is disposed at an angle relative to horizontal surface s, so that end portion 130a of roller 105g in linear roller arrangement 605 is situated vertically further from horizontal surface s than end portion 130d of roller 105n (height h1 is longer than h2). In the operation of roller assembly 600, irregularly shaped granules are fed (F) onto and received by roller assembly 600 at end portion 130a (and at the corresponding end portions of the other rollers in roller assembly 600). As rollers 105g and 105n (and the other rollers) are rotating, the irregularly shaped agglomerate granules are agitated and abraded. Gravitational force provides for migration of the agglomerate granules from end portion 130a along the length (l3) of roller 105g (and the other rollers in roller assembly 600) downwards towards end portion 130d (and toward the corresponding end portions of the other rollers in roller assembly 600). As the agglomerate granules migrate downwards along exterior operative surface 625, irregularly shaped granules are formed into granules from which irregularities on their exterior surface are partially removed, and these granules are then shaped into geometrically more regularly shaped granules. Approximately rounded pellets are discharged (D) from end portion 130d of roller 105n (and the corresponding end portions of the other rollers in roller assembly 600). It is noted that roller assembly 600 readily allows for a continuous flow and processing of granular material.

It is further noted that roller assembly 600 may be operated such that the rollers constituting roller arrangement 605 are operated at a first rotational rate, while the rollers constituting roller arrangement 610 are operated at a second different rotational rate. In some embodiments, the rotational rate at which the rollers constituting roller arrangement 610 are operated is higher than the rotational rate at which the rollers constituting roller arrangement 605 are operated. As hereinbefore noted, operating the rollers constituting arrangement 610 at a higher operational rate may be preferred, since the initial irregularly shaped agglomerate granules are more prone to breakage, and concomitant loss, compared to the more regularly shaped granules as a result of the agitational forces being exerted. Therefore, it may be beneficial to operate the first roller sequence at a slower rotational speed so as not to break the irregularly shaped agglomerate granules but rather smoothen the exterior surfaces of these granules.

It is further noted that roller assembly 600 includes two linear arrangements 605 and 610 that are sequentially arranged with respect to one another (e.g., arrangement 610 is downstream of arrangement 605). In other embodiments, additional planar roller assemblies may be configured and placed relative to the linear roller arrangements 605 and 610 in a sequential fashion to provide an overall roller assembly that extends further along central axis 110gn. In such embodiments, the overall roller assembly may include, for example, 3, 4, 5, 6 or more roller arrangements that are placed downstream of one another in a linear sequence. In the operation of such planar assemblies, each roller arrangement may be operated so that the rollers in each arrangement rotate at the same or different rotational rates.

Referring next to FIG. 6B, shown therein is another example roller assembly 601 for use in the manufacture of substantially rounded pellets from compacted mineral containing agglomerate granules. Roller assembly 601 is a planar roller assembly constituted by two linear roller arrangements 605 and 610, with each arrangement containing a plurality of rollers (e.g., 6, 7, 8, 9, 10 or more rollers; the amount of rollers not visible in the shown cross-sectional view), and roller arrangements 605 and 610 together forming the planar roller assembly that has offset portions. The exterior operative surface 625a, 625b of roller assembly 601 is formed by linear roller arrangements 605 and 610 together. Shown in the cross-sectional view (analogous to the views of FIGS. 1C, 2B and 6A) are rollers 105g and 105n. In each linear roller arrangement 605 and 610, the rollers have an end portion. Shown are, with respect to roller 105g (and linear roller sequence 605) end portions 130a and 130b, and with respect to roller 105n (and linear roller sequence 610), end portions 130c and 130d. Roller 105g has a central axis 110g, and roller 105n has a central axis 110n. End portions 130a, 130b, 130c, and 130d are aligned in such a manner that central axis 110g does not extend directly to central axis 110n, and instead central axes 110g and 110n are axially offset from one another and extend in a parallel fashion. Furthermore, taken together, linear roller sequences 605 and 610 have a length l3.

Continuing to refer to FIG. 6B, it is noted that roller assembly 601 is disposed at an angle relative to horizontal surface s, so that end portion 130a of roller 105g in linear roller sequence 605 is vertically situated further from horizontal surface s than end portion 130d of roller 105n (height h1 is greater than h2). In the operation of roller assembly 601, irregularly shaped granules are fed (F) onto and received by roller assembly 601 at end portion 130a (and at the corresponding end portions of the other rollers in roller assembly 600). As rollers 105g and 105n (and the other rollers) are rotating, the irregularly shaped agglomerate granules are agitated and abraded. Gravitational force provides for migration of the agglomerate granules from end portion 130a along the length (l3) of roller 105g (and the other rollers in roller assembly 601) initially down operational surface portion 625a towards end portion 130b, where the granules are be fed onto operational surface portion 625b. From thereon, the granules migrate towards end portion 130d (and toward the corresponding end portions of the other rollers in roller assembly 601). As the granules migrate downwards along exterior operative surface 625, irregularly shaped granules are formed into granules from which irregularities on their exterior surface are partially removed, and then these granules are processed into geometrically more regularly shaped granules. Approximately rounded pellets are discharged (D) from end portion 130d of roller 105n (and the corresponding end portions of the other rollers in roller assembly 601). It is noted that roller assembly 601 readily allows for a continuous flow and processing of granular material.

As is the case for roller assembly 600, roller assembly 601 may be operated such that the rollers constituting roller arrangement 605 are operated at a first rotational rate, while the rollers constituting roller arrangement 610 are operated at a second different rotational rate. In some embodiments, the rotational rate at which the rollers constituting roller arrangement 610 are operated is higher than the rotational rate at which the rollers constituting roller sequence 605 are operated. As hereinbefore noted, operating the rollers constituting roller arrangement 610 at a higher operational rate may be preferred, since the initial irregularly shaped agglomerate granules are more prone to breakage, and concomitant loss, compared to the more regularly shaped granules as a result of the agitational forces being exerted.

It is further noted that while roller assembly 601 includes two linear arrangements 605 and 610, in other embodiments, roller assemblies may be configured to include additional linear roller arrangements such that the overall roller assembly has a length that extends further. In such embodiments, the overall roller assembly may include, for example, 3, 4, 5, 6 or more linear roller arrangements. In the operation of such planar assemblies each roller sequence may be operated so that the rollers in each roller arrangement rotate at the same or different rotational rates.

It is noted that it may be more convenient to inspect, service or replace parts in roller assembly 601 than roller assembly 600. In particular both end portions and the individual axels of the rollers are more readily accessible in roller assembly 601 for inspection, service, or part replacement than in roller assembly 600.

Referring next to FIG. 7, shown therein is another example roller assembly 700 for use in the manufacture of substantially rounded pellets from compacted mineral containing agglomerate granules. Roller assembly 700 is a tubular roller assembly constituted by two circular roller arrangements 710 and 720, each circular roller arrangement 710 and 720 containing 6 rollers, and circular roller arrangements 710 and 720 together forming tubular assembly 700. The interiorly facing tubular exterior operative surface 730 of roller assembly 700 is formed by central tubular space 740 having central tubular axis 625. Each of the circular roller arrangements 710 and 720 has tubular end portions. Circular roller sequence 710 comprises tubular end portions 530a and 530b, while circular roller sequence 720 comprises end portions 530c and 530d. Tubular end portions 530a, 530b, 530c, and 530d are aligned in such a manner that tubular central axis 725 extends centrally through the entire tubular space that is formed by and extends longitudinally within both circular roller arrangements 710 and 720. Furthermore, together, circular roller arrangements 710 and 720 have a length l4.

Continuing to refer to FIG. 7, tubular assembly 700 is disposed at an angle relative to horizontal surface s, so that end portion 530a of circular roller arrangement 710 is vertically situated further from horizontal surface s than tubular end portion 530d of circular roller arrangement 720 (i.e., height h1 is greater than height h2). In the operation of roller assembly 700, irregularly shaped agglomerate granules are fed (F) into roller assembly 700 at tubular end portion 530a. As the rollers are rotating, the irregularly shaped agglomerate granules are agitated and abraded. Gravitational force provides for migration of the granules from tubular end portion 530a 700 through central tubular space 740 along the length (l4) of tubular assembly 700 downwards towards end portion 530d. As the granules migrate downwards along the interiorly facing tubular exterior operative surface 730, irregularly shaped granules are formed into granules from which irregularities on their exterior surface have been partially removed, and these granules are then formed into geometrically more regularly shaped granules. Approximately rounded pellets are discharged (D) from tubular end portion 530d. It is noted that roller assembly 700 also readily allows for a continuous flow and processing of granular material.

Analogous to linear assembly 600, it is noted that roller assembly 700 may be operated such that the rollers constituting circular roller arrangement 710 are operated at a first rotational rate, while the rollers constituting circular roller arrangement 720 are operated at a second different rotational rate. In some embodiments, the rotational rate at which the rollers constituting circular roller arrangement 720 are operated is higher than the rotational rate at which the rollers constituting roller arrangement 710 are operated. And again, as hereinbefore noted for other embodiments, operating the rollers constituting arrangement 720 at a higher operational rate may be preferred, since the initial irregularly shaped granules are more prone to breakage, and concomitant loss, compared to the more regularly shaped granules as a result of the agitational forces being exerted.

It is further noted that while roller assembly 700 includes two circular roller arrangements 710 and 720, in other embodiments, additional tubular arrangements may be included and configured sequentially along central tubular axis 725 to extend the length of the roller assembly. In such embodiments, the roller assembly may include, for example, 3, 4, 5, 6 or more circular roller arrangements. In the operation of such tubular assemblies each roller arrangement may be operated so that the rollers in each roller arrangement rotate at the same or different rotational rates. For example, the rotational rate of a subsequent roller arrangement may be lower than the rotational rate of a preceding roller arrangement.

As can now be appreciated, the methods of the present disclosure can be used to prepare substantially rounded mineral containing pellets from irregularly shaped compacted mineral containing agglomerate granules. The pellets exhibit desirable storage, handling, and application characteristics.

Of course, the above described example embodiments of the present disclosure are intended to be illustrative only and in no way limiting. The described embodiments may be susceptible to many modifications of composition, details, and order of operation. The embodiments are intended to encompass all such modifications within its scope, as defined by the claims, which should be given a broad interpretation consistent with the description as a whole.

1. A method of forming a plurality of pellets from a plurality of agglomerate granules, comprising the steps of:
(a) feeding the plurality of agglomerate granules on to an operative surface of an assembly of rollers, the rollers having been aligned to have parallel central rotational axes and spaced apart from one another so that there is a longitudinal gap between adjacent rollers, wherein the width of the longitudinal gap is smaller than a size of the pellets;
(b) rotating the rollers to agitate and abrade the agglomerate granules on the exterior operative surface of the assembly of rollers and form substantially rounded pellets; and
(c) discharging the pellets from the rollers.

2. The method of claim 1, wherein the agglomerate granules are irregularly shaped compacted mineral containing granules, and the pellets are mineral containing substantially rounded pellets, wherein optionally the substantially rounded pellets are substantially spherical pellets having a diameter of from about 0.5 mm to about semi-minor axis, being non equal in length, and ranging from about 0.5 mm to about 5.0 mm in length.

3. (canceled)

4. (canceled)

5. (canceled)

6. (canceled)

7. The method according to claim 5, wherein the width of the longitudinal gap between the adjacent rollers is from about 4 mm to about 0.25 mm, or from about 2.5 mm to about 0.25 mm less than the size of the diameter of the substantially spherical pellets or the semi-minor axis of the substantially geometrically spheroidal pellets.

8. The method according to claim 1, wherein the assembly is a planar assembly in which the rollers are arranged in a linear planar format.

9. The method according to claim 8, wherein the planar assembly is angled relative to a horizontal surface that supports the planar assembly, the rollers having first and second end portions, the second end portions being positioned vertically closer to the horizontal surface than the first end portions, and wherein the agglomerate granules are fed onto the operative surface at the first end portions of the rollers, conveyed along the operative surface in the longitudinal direction and discharged near the second end portions of the rollers.

10. The method according to claim 1, wherein the assembly is a tubular assembly formed by a circular arrangement of rollers where the rollers are arranged so that there is an approximately tubularly shaped space at a center of the assembly of rollers, the approximately tubularly shaped space having first and second tubular spatial end portions and a central tubular axis that is parallel to central rotational axes of the rollers, wherein the agglomerate granules are received by the first or second tubular spatial end portion.

11. The method according to claim 10, wherein the assembly of rollers are arranged so that the central tubular axis is angled relative to a horizontal surface that supports the tubular assembly so that the first tubular spatial end portion is vertically positioned higher relative to the horizontal surface than the second tubular spatial end portion, wherein the agglomerate granules are fed into the first tubular spatial end portion, conveyed longitudinally through the tubular space, and discharged at the second tubular spatial end portion.

12. The method according to claim 1, wherein the rollers are operated at the same rotational rate or the rollers are all operated at a first rotational rate for a first period of time, and are thereafter all operated at a second rotational rate for a second period of time, the second rotational rate being higher than the first rotational rate.

13. (canceled)

14. The method according to claim 1, wherein the agglomerate granules are fed on a roller assembly comprising a plurality of roller arrangements that are sequentially ordered, each roller arrangement having multiple rollers, and each roller arrangement is disposed in a linear or circular arrangement, wherein the rollers in each roller arrangement are operated at the same rotational rate, and wherein starting with a first roller arrangement, the rollers in each subsequent roller arrangement, are operated at an incrementally higher rotational rate, and wherein the agglomerate granules are fed to a first roller arrangement, conveyed along subsequent roller arrangements and discharged from a final roller arrangement.

15. The method according to claim 14, wherein each arrangement is a linear planar arrangement, wherein the central axes of the rollers in at least one roller arrangement extend co-linearly to the central axes of the rollers of at least one other roller arrangement.

16. The method according to claim 14, wherein the arrangement is a linear planar arrangement, wherein the central axes of the rollers in at least one roller arrangement extend in parallel with the central axes of the rollers of at least one other roller arrangement, wherein the central axes of the at least one roller arrangement are axially offset from the central axes of the at least one other roller arrangement.

17. The method according to claim 1, wherein the assembly is a planar assembly disposed within an enclosed housing to prevent spillage of agitated agglomerate granules from operative surfaces of the rollers.

18. The method according to claim 1, wherein the rollers have a length in the range of about 50 cm to about 4 m.

19. The method according to claim 1, wherein the method comprises heating the agglomerate granules at a temperature from about 30° C. to about 300° C. before feeding the agglomerate granules onto an operative surface of the assembly of rollers.

20. (canceled)

21. (canceled)

22. (canceled)

23. The method according to claim 2, wherein the mineral contained in the plurality of irregularly shaped compacted mineral containing granules is a potassium containing water soluble salt, or a phosphate containing water soluble salt, wherein optionally the potassium containing salt is a single salt, wherein optionally the single salt is selected from KCl, K₂SO₄ and KNO₃, or wherein optionally the potassium containing salt is a multiple salt or wherein optionally the potassium containing salt is a multiple salt selected from K₂SO₄—MgSO₄—(CaSO₄)₂-2H₂O, K₂SO₄(MgSO₄)₂, K₂SO₄—MgSO₄-4H₂O, K₂SO₄—MgSO₄-6H₂O, and KCl—MgSO₄-2.75H₂O.

24. (canceled)

25. (canceled)

26. (canceled)

27. (canceled)

28. (canceled)

29. A plurality of substantially rounded mineral containing pellets manufactured according to the method as defined in claim 2.

30. (canceled)

31. A roller assembly for forming a plurality of pellets from a plurality of agglomerate granules, wherein the roller assembly comprises a plurality of rollers aligned to have parallel central rotational axes and a longitudinal gap between adjacent rollers, wherein the width of the longitudinal gap is smaller than a size of the pellets.

32. (canceled)

33. (canceled)

34. (canceled)

35. A roller assembly according to claim 31, wherein the roller assembly is a planar assembly in which the rollers are arranged in a linear format, wherein optionally the planar assembly is angled relative to a horizontal surface that supports the planar assembly, the rollers having first and second end portions, the second end portions being positioned vertically closer to the horizontal surface than the first end portions.

36. (canceled)

37. (canceled)

38. A roller assembly according to claim 31, wherein the roller assembly is a tubular assembly formed by a circular arrangement of the rollers where the rollers are arranged so that there is an approximately tubularly shaped space between the rollers, the approximately tubularly shaped space having first and second tubular spatial end portion and a central tubular axis that is parallel to central rotational axes of the rollers, wherein in optionally the roller assembly is arranged so that the central tubular axis is angled relative to a horizontal surface that supports the tubular assembly so that the first tubular spatial end portion is vertically positioned higher relative to the horizontal surface than the second tubular spatial end portion.

39. (canceled)

40. A roller assembly according to claim 31, wherein the roller assembly comprises a plurality of roller arrangements, each roller arrangement having multiple rollers, and each roller arrangement being arranged in a linear or circular format, wherein optionally the arrangement is a linear arrangement, wherein the central axes of the rollers in at least one roller arrangement extend co-linearly to the central axes of the rollers of at least one other roller arrangement, or wherein optionally the arrangement is a linear arrangement, wherein the central axes of the rollers in at least one roller arrangement extend in parallel with the central axes of the rollers of at least one other roller arrangement, wherein the central axes of the at least one roller arrangement are axially offset from the central axes of the at least one other roller.

41. (canceled)

42. (canceled)

43. (canceled)

44. (canceled)
